(19) United States
(12) Patent Application Publication
(10) Pub. No.: US 2015/0186908 A1
(43) Pub. Date: Jul. 2, 2015

(54) METHOD AND SYSTEM FOR ACCELERATING PAYMENT CARD USAGE BEHAVIOR CHANGE

(71) Applicant: MASTERCARD INTERNATIONAL INCORPORATED, Purchase, NY (US)

(72) Inventors: Damla Taskin, Waterloo (BE); Tuuli Perkio, Waterloo (BE)

(73) Assignee: MASTERCARD INTERNATIONAL INCORPORATED, Purchase, NY (US)

(21) Appl. No.: 14/142,288

(22) Filed: Dec. 27, 2013

(51) Int. Cl. G06Q 30/02

(52) U.S. Cl. CPC G06Q 30/0204

(57) ABSTRACT

A method and a system for accelerating payment card usage behavior change of a payment card user are provided. The method includes identifying a number of merchant categories associated with payment card usage by a payment card user, and associating payment card usage by the payment card user with an increasing number of merchant categories. The method identifies the natural migration of a consumer across the stages, which is linked to the number of merchant categories they feel comfortable using the payment card. By understanding how a consumer migrates across the stages, the merchant categories that accelerate behavior change can be identified. This accelerate behavior change five stage framework and many of the insights about attitudinal differences between the stages can be applied to markets (e.g., mature, advanced and emerging), and particularly that the number of merchant categories in which a consumer feels comfortable using his/her payment card is an important driver of debit usage.

### BACKGROUND OF THE DISCLOSURE

1. Field of the Disclosure

The present disclosure relates to a method and a system for accelerating payment card usage behavior change of a payment card user.

2. Description of the Related Art

Encouraging consumer adoption and increased use of debit cards has been a goal for all card issuers to either drive revenue or achieve cost savings of alternative payment methods. Yet getting consumers to develop a debit card payment habit can be a challenging process since it often involves overcoming certain strongly-held perceptions that using cash provides greater control, security and ease. Despite certain dissimilarities in different market types, ample evidence was uncovered that the common payment attitudes exist among consumers in all market types.

Consumer use of debit cards today is almost as varied as the range of merchants where such cards are accepted. For example, in emerging markets, debit cards are primarily used for the withdrawal of cash from ATMs. Meanwhile, in more mature debit payment markets, consumers have increasingly embraced debit cards for use in POS transactions as a substitute for cash.

Discovering and quantifying what prompts consumers to migrate from using cash for day-to-day purchases to using debit cards as their preferred means for such transactions would be valuable to card issuers and other entities, given the significant potential card transactions offer for added revenue and enhanced cost savings versus other payment methods.

Thus, it would be desirable to identify how consumers migrate from the exclusive use of cash for point-of-sale (POS) transactions to adopting debit cards as their primary payment tool. It would also be desirable to identify and quantify what can be done to accelerate a behavior change from a cash only to a debit card payment habit.

### SUMMARY OF THE DISCLOSURE

The present disclosure provides an accelerate behavior change five stage framework for how consumers migrate from the exclusive use of cash for point-of-sale (POS) transactions to adopting debit cards as their primary payment tool. A stage is identified by number of merchant categories that a consumer feels comfortable using his or her card. This accelerate behavior change framework and many of the insights about attitudinal differences between the stages can be applied to markets (e.g., mature, advanced and emerging), and implies particularly that the number of merchant categories in which a consumer feels comfortable using his/her payment card is an important driver of debit usage. The recommendation of the accelerate behavior change five stage framework of this disclosure is the right message (e.g., well targeted) to the right person (e.g., to the relevant stage) at the right time.

The present disclosure also provides a method for accelerating payment card usage behavior change of a payment card user. The method identifies the natural migration of a consumer across the stages, which is linked to the number of merchant categories they feel comfortable using the payment card. By understanding how a consumer migrates across the stages, the merchant categories that accelerate behavior change can be identified. In particular, a method for accelerating payment card usage behavior change of a payment card user is provided that comprises identifying the number of merchant categories associated with payment card usage by a payment card user, and associating payment card usage by the payment card user with an increasing number of merchant categories.

The present disclosure further provides a method comprising: determining a plurality of behavior category classifications based upon payment card usage, wherein the behavior category classifications range from cash only behavior to payment card only behavior; identifying a number of merchant categories associated with each of the plurality of behavior category classifications; identifying a number of merchant categories associated with payment card usage by a payment card user; and associating the payment card user with at least one behavior category classification based upon the number of merchant categories associated with payment card usage by the payment card user that correspond with the number of merchant categories associated with the behavior category classification.

The present disclosure yet further provides payment card usage behavior category classification system. The system comprises the following: optionally a control stage which comprises a strong cash use preference behavior; a first stage which comprises payment card necessity or confined payment card use behavior; a second stage which comprises incidental payment card use behavior; a third stage which comprises regular payment card use building behavior; a fourth stage which comprises payment card use habit forming behavior; and a fifth stage which comprises strong payment card use preference behavior.

The present disclosure also provides system comprising: one or more computers having computer readable mediums having stored thereon instructions which, when executed by one or more processors of the one or more computers, causes the system to perform the stages of: determining a plurality of behavior category classifications based upon payment card usage, wherein the behavior category classifications range from cash use preference behavior to payment card use preference behavior; identifying a number of merchant categories associated with each of the plurality of behavior category classifications; identifying a number of merchant categories associated with payment card usage by a payment card user; and associating the payment card user with at least one behavior category classification based upon the number of merchant categories associated with payment card usage by the payment card user that correspond with the number of merchant categories associated with the behavior category classification.

### BRIEF DESCRIPTION OF THE DRAWINGS

FIG. 1 is a summary of the accelerate behavior change five stage framework of this disclosure that includes stage descriptions, payment card user profiles, the number of merchant categories associated with each stage, and key spend characteristics of the payment card users.

FIG. 2 is a summary of the different phases of debit adoption and migration over time that defines the accelerate behavior change five stage framework of this disclosure.

FIG. 3 is a summary of the accelerate behavior change five stage framework of this disclosure that includes a description of merchant categories for each of the five stages.

A component or a feature that is common to more than one drawing is indicated with the same reference number in each drawing.

### DESCRIPTION OF THE EXEMPLARY EMBODIMENTS

Embodiments of the present disclosure are described more fully hereinafter with reference to the accompanying drawings, in which some, but not all, embodiments of the disclosure are shown. Indeed, the disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

As used herein, an emerging market is a market where 90% of the transactions are settled in cash, with acceptance challenges and weak ATM infrastructure. As used herein, an advanced market is a market where cash accounts approximately for 45% of all transactions, with strong acceptance levels, as well as strong debit penetration but still reluctance to use debit at POS regularly and reliance on cash. As used herein, a mature market is a market where the majority of transactions are settled by payment card, with high debit acceptance and popular mobile banking apps, as well as other leading edge practices. In advanced markets, only about 8% of the consumers are cash only users.

Although it has been the prevailing belief that a debit card payment habit is acquired only through the sheer volume of point-of-sale (POS) transactions consumers complete, this disclosure shows that other factors are important for acquiring a debit card payment habit. In accordance with this disclosure, it has been found that the breadth or diversity of categories in which consumers are comfortable using their debit card is a significant driver of habitual card activity.

Also, in accordance with this disclosure, an accelerate behavior change five stage framework has been identified of how consumers migrate from the sole use of cash for POS transactions to adopting debit cards as their primary payment tool. Once consumers reach the fourth and fifth stages, debit does not totally eliminate the need for cash, in fact, ATM withdrawals and cash transactions increase in number, but cash does become considerably less prominent in the payments mix as reflected by a decline in the percentage of transactions.

Further, in accordance with this disclosure, it has been found that merchant trust is the key driver of consumer confidence to use debit. Money management, fear of fraud and loss are overarching influences that affect debit usage in varying ways at each stage, with many customers being largely unaware of existing card security features, however those issues have different meanings at each stage. Internet use and “not having a choice” are major factors contributing to initial debit use.

This accelerate behavior change five stage framework and the attitudinal differences between the stages have major implications for how issuers think about their payment optimization strategies. In particular, there are a number of action themes that banks should consider exploring to drive behavior change. These include disrupting the current view of consumers' money management system and addressing their varying control and money management needs. Likewise, banks should look at aligning customer treatments with category preferences across the stages.

The stages and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions can also be loaded onto a computer or other programmable data processing apparatus to cause a series of operational stages to be performed on the computer or other programmable apparatus to produce a computer-implemented process so that the instructions which execute on the computer or other programmable apparatus provide stages for implementing the functions/acts specified in the flowchart and/or block diagram block(s). Alternatively, computer program implemented stages or acts can be combined with operator or human implemented stages or acts in order to carry out an embodiment of the present disclosure.

In accordance with this disclosure, it has been found and quantified as to what prompts consumers to migrate from using cash for day-to-day purchases to using debit cards as their preferred means for such transactions. This disclosure provides insights into the drivers of debit adoption. The consumer insights provide deeper understanding of the transaction analysis and are complemented with market-level data to understand external factors that can impact debit adoption.

In accordance with this disclosure, it has been found that the evolution of consumers' debit card payment behavior among consumers occurs according to a defined accelerate behavior change five stage framework. For consumer migration from a strong cash use preference behavior to a strong payment card use preference behavior, the stage migration begins with very limited debit usage and then progresses steadily from incidental to regular use based on a wide variety of factors. Additionally, this disclosure paints a strong profile of consumers at each stage, including their approaches to money management, security, as well as behavior patterns and demographic characteristics.

In accordance with this disclosure, it has been found that the breadth or diversity of merchant categories in which consumers are inclined to use their cards represents an important engagement driver for habitual card activity. The quantity of POS transactions they make, which is typically the most common key performance indicator of consumer adoption, has been found not to be as important. Furthermore, the necessity of using a debit card, such as for an online purchase or because no other option is available, is a more important trigger for first-time usage than an emergency or a planned one-off acquisition.

As category breadth or diversity has been found to be an important factor in debit adoption, it is logical basis for delineating the different stages within the accelerate behavior change five stage framework model of this disclosure. The following are brief definitions of the stages, including some of the attitudes and characteristics of consumers at each level:

Control Stage or Stage 0: Cash Only

The consumers of this stage have a strong emotional connection to cash. They have routinely made withdrawals from ATMs for years and see no reason to change.

First Stage or Stage 1: Debit Necessity or Confined Use (1 category)

The payment card users of this stage are still tied very strongly to cash, but have overcome the first-time-usage barrier, whether out of necessity, an emergency or a planned one-off acquisition.

Second Stage or Stage 2: Incidental Use (2-4 Categories)

The payment card users of this stage prefer cash for its immediacy and tangibility, yet have subconsciously expanded debit usage to include purchases with trusted retailers in multiple “first-use” categories.

Third Stage or Stage 3: Building to Regular Use (5-10 Categories)

For the payment card users of this stage, cash remains a part of everyday life, but are increasingly choosing debit for use in such core categories as grocery, fuel and clothing.

Fourth Stage or Stage 4: Habit is Formed (11-20 Categories)

The payment card users of this stage are confident debit users whose card usage is tempered by a need for reassurance in unfamiliar surroundings and visible evidence of merchant acceptance.

Fifth Stage or Stage 5: Debit Devoted (20+ categories)

The payment card users of this stage want to use their card whenever and wherever possible. Typically, they carry very little cash, if any, and can become frustrated when merchants don't accept debit.

Further to these distinctions, in accordance with this disclosure, data can be used to develop more extensive portraits of consumers at each stage. These portraits go beyond their general attitude about debit use to address their feelings about money management and their openness to change. In addition, the portraits can show, for example, the consumers' average number of debit transactions per month, the combined value of those transactions, and the categories in which they are most likely to use their card.

As an illustration, the following is a portrait of those consumers who have moved up from Stage 2 to Stage 3, which is where debit usage grows most dramatically. At this level, depending on the market (e.g., mature, advanced and emerging), consumers are starting to see debit's worth as a money management tool, and are averaging nine transactions a month. Still, they compartmentalize their payment preferences by merchant, for instance, opting to use cash for fast-food restaurants, transport and other low-value payments, and as a means of control under certain circumstances, such as a night on the town.

Beyond enabling the creation of the detailed portraits, the method and system of this disclosure provide valuable insights about consumers' use of cash and debit during the migratory process, as well as the factors contributing to their payment attitudes.

In accordance with this disclosure, it has been found that the increasing use of debit at POS does not eliminate the need for cash. As consumers progress through the five stages, the number of their cash transactions increases. However, at the same time, cash does play a less prominent role in the payments mix between debit and cash, with the percentage of cash transactions declining.

Even at the upper stages, though consumers are confident with their debit use within their countries, they remain unwilling to use their cards overseas, often because they believe any problems resulting from international use will be difficult to sort out, and also there is a lack of confidence in the card payment security of the country in overseas. Other reasons for this reticence include a preference for compartmentalizing holiday funds.

The prevalence of different industries at each stage reflects consumers' varying definitions of merchant trust and approaches to money management. At lower stages, debit usage is typically most common in core categories, such as grocery, fuel and for big ticket purchases, while only at the upper stages is debit used for socializing, health and personal care, and other discretionary spending areas.

The predominance of certain categories at lower stages, specifically information, finance and insurance, and big ticket industries, shows that Internet purchases and “not having a choice” are often reasons consumers initially use debit cards.

Control of spend and robust money management are important needs across all stages, but have different meanings based largely on how emotionally tied to cash consumers are. At lower stages, cash is the means of control, along with ATMs, because consumers value its immediacy and tangibility, while at the upper stages, those needs are replaced by the recognition of debit's ability to easily track spending.

Particularly at lower stages, consumers perceive cash as faster than debit and providing them greater access because of its universal acceptance. These perceptions are often reinforced by negative attitudes toward debit on the part of some merchants, who keep their terminals hidden from sight or apply surcharges on low-level card payments.

Fear of fraud and loss are also major factors influencing the usage of debit cards. Even those consumers at upper stages can be unfamiliar with debit's security advantages in a new or unknown situation, such as purchasing abroad.

When observed over time, a proportion of consumers in all stages can show some natural propensity to change. However, it is wrong to assume that a gradual migration upward will naturally occur. In some instances, a continuous program of activities can be needed not just to overcome inertia among some consumers and encourage upward movement, but also to stem the tendency of some volatile groups to go backwards. The recommendation of the accelerate behavior change five stage framework of this disclosure is the right message (e.g., well targeted) to the right person (e.g., to the relevant stage) at the right time.

The business implications of the method and system of this disclosure include many points that are important for debit card issuers to note. For example, ATMs remain an integral part of consumers' lives at all stages, so they should be seen as a prime means of communicating messages that target behavioral change. Strategically reviewing ATM location deployment can be critical to helping offset ATM disloyalty among consumers at the upper stages. Perceptions around debit card acceptance will need to be addressed at all stages. International use of debit cards at upper stages represents a strong incremental revenue opportunity. Category spend insights and customer rationale provide clear direction for optimizing marketing spend.

In order to drive the desired customer behavior in accordance with the method and system of this disclosure, banks can identify a series of action themes for each stage and then consider different tactics for executing those themes. Among the primary themes should be those that accomplish the following: align customer treatments with category specificities across the stages; disrupt the current view of consumers' money management system and address varying control and money management needs; raise awareness about the convenience of debit, as well as the security features and benefits of card usage; leverage other strong influencers, such as a customer's family members, e.g. partner, younger family members; and create a stronger banking relationship as part of driving debit engagement.

The accelerate behavior change five stage framework includes an extended data set (current account, debit, ATM and credit behavior), as well as analysis of market factors. It has been found that a diversity of merchant categories is an important engagement driver rather than number of POS transactions. In addition, card necessity was uncovered as an additional first time usage trigger, together with planned one-off purchases and emergency.

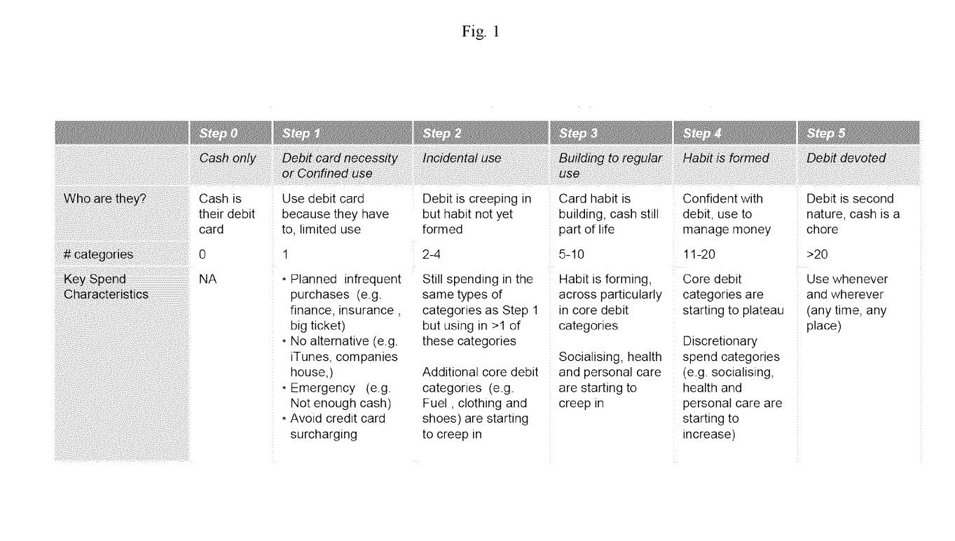

Referring to the drawings and, in particular, FIG. 1, a summary of the accelerate behavior change five stage framework of this disclosure is shown that includes stage descriptions, payment card user profiles, the number of merchant categories associated with each stage, and key spend characteristics of the payment card users.

The control stage or Stage 0 is cash only. The first stage or Stage 1 is debit card necessity or confined use. The second stage or Stage 2 is Incidental use. The third stage or Stage 3 is building to regular use. The fourth stage or Stage 4 is the formed habit. The fifth stage or Stage 5 is debit devotion.

The payment card user behavior can be categorized in accordance with the stages. For the control stage or Stage 0, cash is the payment card user's debit card. For the first stage or Stage 1, debit cards are used by payment card users because they have to, e.g., limited use. For the second stage or Stage 2, debit is creeping in but habit not yet formed. For the third stage or Stage 3, the card habit is building, and cash still part of everyday life. For the fourth stage or Stage 4, the payment card users are confident with debit, and use the payment card to manage money. For the fifth stage or Stage 5, debit is second nature to the payment card user, and cash is a chore.

In accordance with this disclosure, there are number of merchant categories associated with each of the plurality of behavior category classifications or stages described herein. The accelerate behavior change five stage framework of this disclosure has identified a number of categories associated with each stage depending on the market (e.g., mature, advanced or emerging). As the stages progress, the higher stages include an increased number of merchant categories. The increased number of merchant categories is responsible for accelerating payment card usage behavior change of a payment card user.

For an emerging market, the first stage comprises at least one 1 merchant category, the second stage comprises from about 2 to about 3 different merchant categories, the third stage comprises from about 4 to about 6 different merchant categories, the fourth stage comprises from about 7 to about 14 different merchant categories, and the fifth stage comprises from about 15 to about 35 different merchant categories.

For an advanced market, the first stage comprises at least 1 merchant category, the second stage comprises from about 2 to about 4 different merchant categories, the third stage comprises from about 5 to about 10 different merchant categories, the fourth stage comprises from about 11 to about 20 different merchant categories, and the fifth stage comprises from about 21 to about 41 different merchant categories.

For a mature market, the first stage comprises at least 1 merchant category, the second stage comprises from about 2 to about 4 different merchant categories, the third stage comprises from about 5 to about 9 different merchant categories, the fourth stage comprises from about 10 to about 22 different merchant categories, and the fifth stage comprises from about 23 to about 52 different merchant categories.

Key payment card user spend characteristics are associated with each of the stages of the accelerate behavior change five stage framework of this disclosure. The accelerate behavior change five stage framework of this disclosure identifies the natural migration of a consumer across the stages, which is linked to the number of merchant categories they feel comfortable using the payment card. By understanding how a consumer migrates across the stages, the merchant categories that accelerate behavior change can be identified.

Various payment behaviors have been identified as a result of the accelerate behavior change five stage framework of this disclosure. For example, debit payments do not eliminate the need for cash, but cash is less prominent in the payments mix as debit payment adoption grows. Customers in higher stages of the accelerate behavior change five stage framework demonstrate greater ATM disloyalty (as they are not dependent on ATMs for money management), however this is offset by higher POS revenues generated in the higher stages. Meaningful levels of POS use starts at the third stage or Stage 3, but this appears to be largely sub-conscious on the part of the payment card user. It is not until the fourth stage or Stage 4 that payment card user's attitudes change and they pro-actively use debit as their preferred payment method in most circumstances. Understanding attitudinal differences (even if transaction behavior looks similar) is a key to designing effective customer treatments. Merchant trust and individual approaches to money management are key drivers of consumer confidence to use payment cards in different categories. Internet use and not having a choice have been found to be key drivers of initial debit use in the lower stages.

Various payment attitudes have been identified as a result of the accelerate behavior change five stage framework of this disclosure. Control of spend and robust money management are key needs across all stages. In the lower stages, cash provides control, but in the higher stages, its debit that provides control. Fear of fraud is an overarching influence on payment card usage. Customers are largely unaware of existing card security features. Lack of understanding around charge back rights may inhibit payment card use. Customers typically are unaware of product functionality and benefits. External market factors (e.g. chip and PIN, decline in check acceptance) have been found to be key drivers of debit payment adoption across the stages of the accelerate behavior change five stage framework. Speed and access create inertia in the lower stages as there is a perception that cash is quicker than POS. Acceptance concerns are still an issue and may be aggravated by negative merchant experiences.

In the accelerate behavior change five stage framework of this disclosure, the payment card user migrates from one behavior category classification to another behavior category classification based on payment card usage by the payment card user that includes an expanded diversity of merchant categories. Stages 1, 2 and 3 show the greatest propensity for a payment card user to naturally migrate. Larger revenue opportunities can be found in higher stages owing to segment size and likely incremental behavior shift. A well segmented targeting as well as the right communication message program of activities is needed to sustain behavior change and mitigate any backwards movement.

Several actions can be taken by entities for promoting the accelerate behavior change five stage framework of this disclosure and accelerating payment card usage behavior change of a payment card user. For example, targeted education messages, incentives to drive behavior change (e.g., category expansion campaigns), internal communications, overseas spend initiatives, review and enhancement of key operational policies. Other actions can include, for example, product development and enhancements designed to support money management needs of the customer, address low value payments, and alleviate fraud concerns. Still further actions include initiatives to strengthen the overall banking relationship and in turn drive debit use, and acceptance expansion.

The accelerate behavior change five stage framework originated from insights that sought to identify key drivers of debit adoption and customer profitability. It has been found that consumers migrate from cash (branch withdrawals), to ATM, to debit over time. Market level transaction analysis illustrate periodic ATM use is the entry point, followed by increased ATM use before debit trial. As debit use increases, ATM usage is sustained. In mature payment card markets, payment card habits include both debit payments and ATM use. The accelerate behavior change five stage framework of this disclosure leads to a payment card habit. As consumers become accustomed to debit payments, the debit transactions increase.

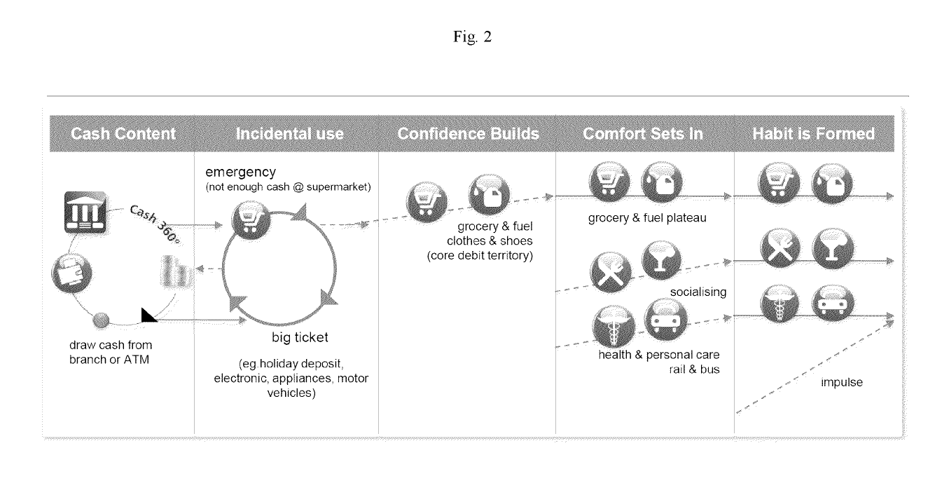

Using market level data, the different phases of debit adoption and migration were mapped over a period of time to create the accelerate behavior change five stage framework of this disclosure. Referring to FIG. 2, in the cash content phase, cash is drawn from a branch or ATM. The incidental use phase includes emergency (e.g., not enough cash at the supermarket); big ticket (e.g., holiday deposit, electronic, appliance, motor vehicles), and the like. The confidence build phase includes grocery and fuel; clothes and shoes (core debit territory), and the like. In the comfort set in phase, groceries and fuel plateau. The comfort set in phase also includes socializing; health and personal care; rail and bus, and the like. The habit is formed phase includes groceries and fuel; socializing; health and personal care; rail and bus; impulse, and the like.

Referring to FIG. 2, analysis based on transaction volumes and category spend was used to define the different stages of the accelerate behavior change five stage framework. In earlier stages, consumers are more likely to maintain or decrease their level of payment card usage rather than grow payment card usage. Two points of entry for initial debit card use were identified that included emergency (e.g., unplanned when insufficient cash on hand) and large ticket (e.g., planned for a higher cost purchase). In some instances, breaking the cycle to a more regular debit payment use can necessitate an emergency transaction. A use for planned purchases may not be sufficient. It has been found that debit transactions increase as comfort with debit increases. Increase in breadth or expanded diversity of merchant categories is a strong driver of incremental use.

The accelerate behavior change five stage framework of this disclosure can include an extended data set with an overlay of research and market factors to validate and complete the picture. The extended dataset can include, for example, analysis of issuer data (e.g., current account data, primary banking, debit and credit card behavior and merchant filter), definition of debit and credit stages (e.g., identification of above and below share in certain key categories such as big ticket and socializing), customer insight and research (e.g., qualitative research to understand behaviors and triggers to drive stage movement), market scan and impacts (e.g., impact of external factors on payments behavior such as ATM penetration), and segment profiles (e.g., detailed understanding of customers in each of the stages). This extended data set can help develop debit card strategies to migrate payment card users from ATM to POS.

In the accelerate behavior change five stage framework of this disclosure, the larger stages can be divided into sub-stages in order to provide a better and more accurate segmentation. For example, the control stage or Stage 0 can have four distinct cash groups. Also, it has been found that card necessity is an additional first time usage trigger.

In the control stage or stage 0 (cash only), cash is drawn from a branch or ATM. In a stage 0.1, less than 4 transactions per month and less than $100 per transaction occurs. In a stage 0.2, less than 4 transactions per month and greater than $100 per transaction occurs. In a stage 0.3, greater than 4 transactions per month and less than $100 per transaction occurs. In a stage 0.4, greater than 4 transactions per month and greater than $100 per transaction occurs.

The first stage or Stage 1 (debit card necessity or confined use) includes, for example, emergency (e.g., not enough cash at the supermarket), planned one-off (e.g., holiday deposit, electronic, appliance, motor vehicles), no alternative (e.g., I-Tunes, companies house, mail order), and the like. In the sub-stage 1.1, up to 1 transaction per month emergency or planned one-off purchases (card necessity) occur. In the sub-stage 1.2, greater than 1 transaction per month occurs, confined spenders (e.g., I-tunes).

The first stage or Stage 1 has broken the first time debit use barrier but hold similar concerns to Stage 0 around control and money management. The payment card users in the first stage revert to cash in most cases.

Profiles or portraits have been created for the payment card users in each of the stages of the accelerate behavior change five stage framework. Debit use, money management, openness to change, cash: POS ratio (% of transactions), hierarchy of needs, and male/female split were all evaluated as part of the profiles or portraits.

Payment card user profiles or portraits for the control stage or Stage 0 are as follows: debit use—routine ATM users, cash is their debit card; money management—fear losing control of spend, cash and ATMs are their money management tool; openness to change—comfortable with current approach, see no reason to change; cash: POS ratio (% of transactions)—100% cash; hierarchy of needs—control, security and ease/speed; and male/female split—51% male/49% female.

For the payment card users in the control stage or Stage 0, cash is their debit card. They have a strong emotional tie to cash. It is their money and they can't afford to lose it. It is their lifeline and they need to protect it, for example, from fraud and from overspending. The payment card users in this stage typically lack of self confidence in managing their finances. They believe cash is the best solution (quick and easy), and have created a money management solution using cash that they feel comfortable with. They are not fully aware of alternative payment and money management solutions or don't see them as reliable. Despite having a fully functioning debit card, ATM use is routine, not spontaneous and not considered an extra stage. They believe cash is safer than the payment card (their loss is limited to what's in their pocket). They perceive confusion between debit and credit (all cards are bad/temptation/evil). They have strongly held beliefs that are engrained and influenced by others, for example, family, press, merchants, and the like. They typically don't believe that banks are working for their benefit.

Payment card user profiles or portraits for the first sub-stage or Stage 1.1 are as follows: debit use—have used debit out of necessity, not choice, and only at trusted merchants; money management—either prefer using credit card for their day to day spend or see cash and ATMs as the most effective money management tools; openness to change—accepting of change but do not seek it; cash: POS ratio (% of transactions)—87% cash; 12% POS; 1% cashback; hierarchy of needs—control, access and ease/speed; and male/female split—53% male/47% female.

For the payment card users in the first sub-stage or Stage 1.1, they have used debit but only because they had to. A mix of payment behaviors and attitudes are present with some customers citing a preference for credit while others remain wedded to cash. Use of debit card was out of force, not choice (e.g., Internet, online discounts, insurance, to avoid credit card surcharging). There is a possibility that for some payment card users in this stage, a competitor credit card is their primary payment tool (e.g., payments to credit card companies are prominent in the finance and insurance merchant list which strongly over-indexes in this stage). Those who are using cash as their primary payment tool exhibit similar money management attitudes as in Stage 1.2.

Payment card user profiles or portraits for the second sub-stage or Stage 1.2 are as follows: debit use—exhibit regular debit use but only in confined circumstances (i.e., 1 category)—either because of card necessity or to maintain control over spend; money management—feel on the verge of being out of control—cash and ATM still core components of money management routine; openness to change—need to be convinced about the need to change; cash: POS ratio (% of transactions)—55% cash; 42% POS; 3% cashback; hierarchy of needs—control, access and ease/speed; and male/female split—52% male/48% female.

For the payment card users in the second sub-stage or Stage 1.2, they are only comfortable using in one merchant category in order to control their spend. They have a strong emotional tie to cash. The fear of loss is outweighed by immediate benefit that cash is perceived to bring. They are hard core money managers with home grown solutions. ATM is their money management tool. A debit card is not seen as a viable budgeting tool (perceived fears of debt, lost card, fraud and the like). The confined category breadth is driven by: need to track spend (they believe they can track debit spend if just in one category, alleviates fear of overdraft from uncleared transactions); and forced used (e.g., Internet, online discounts, insurance, to avoid credit card surcharging). They are only comfortable using payment cards in established and trusted merchants (supports need to protect their money and to avoid embarrassment if card is refused). They need to be convinced about need to change. Use of competitor credit cards as a primary payment tool is also more likely for the payment card users in this stage.

It has been found that payment card users in the second stage or stage 2 exhibit greater control of spend than payment card users of the first stage or Stage 1. It has also been found that increased merchant category use in these two stages is subconscious. The payment card users in both Stages 1 and 2 are content with cash and see no reason to change.

Payment card user profiles or portraits for the second stage or Stage 2 are as follows: debit use—debit is creeping in subconsciously (with trusted retailers) but usage not always sustained; money management—feel in control of their spending, satisfied with money management approach—cash forms a major part of this; openness to change—open to alternatives if given a reason to change behavior; cash: POS ratio (% of transactions)—54% cash; 43% POS; 3% cashback; hierarchy of needs—control, security and rewards. male/female split—52% male/48% female.

For the payment card users in the second stage or Stage 2, debit is creeping in sub-consciously but habit is not yet formed. They are habitual cash users with no desire or reason to change. They have strong emotional ties to cash but the need for tangibility replaces that of immediacy. Debit is creeping in subconsciously (with trusted retailers) but usage in new categories is not always sustained. The debit payment habit has not yet formed. They are focused on money management but current habits provide the control they need (ATM forms core part of this). They are still concerned about security risk of card but they are starting to see security pitfalls of cash. Credit cards do not play a large part in their money management system. If a credit card is held, it is unlikely to be used.

It has been found that the payment card users of the third stage or Stage 3 are building a card habit but only where they feel control over spend with debit payments.

Payment card user profiles or portraits for the third stage or Stage 3 are as follows: debit use—card habit is building but cash still perceived as more appropriate in certain circumstances; money management—starting to understand benefits of debit as a money management tool—still use cash for control when they fear overspend; openness to change —payments behavior is subconscious, following what they have seen others do, indifferent to changing it; cash: POS ratio (% of transactions)—35% cash; 63% POS; 2% cashback; hierarchy of needs—control only; and male/female split—47% male/53% female.

For the payment card users in the third stage or Stage 3, the card habit is building but cash is still a part of everyday life. They are subconscious card users with no major skew in category preference. They have an indifference to changing their behavior. Card habit is building, but cash still a part of everyday life. Payment preferences are compartmentalized across different types of merchants (e.g., will only pay cash for McDonalds). They largely follow what they have seen others do. They are starting to view debit as a money management tool but still use cash where they feel they should (e.g., transport) or as a means of control in some circumstances (e.g., on a night out). They view credit cards as a false indicator of wealth, and don't want to get into debt. They use ATMs for balance enquiries.

It has been found that the fourth stage or Stage 4 shows a major attitude change and payment card users are using in most places.

Payment card user profiles or portraits for the fourth stage or Stage 4 are as follows: debit use—merchant trust a key factor in broader category use; money management—debit is now their money management tool; cash still provides control x-border; openness to change —open to changing behavior if barriers to further use (internal and external) are removed; cash: POS ratio (% of transactions)—23% cash; 75% POS; 2% cashback; hierarchy of needs—security, acceptance and ease/speed; and male/female split—42% male/58% female.

For the payment card users in the fourth stage or Stage 4, they are confident debit users and debit is their money management tool. They are in control of their financial management and use their debit card as the money management tool. They yearn to exploit the benefits of debit from spontaneous usage of their card. They want to increase usage of their card, but need physical evidence of merchant acceptance. They want to ensure security of the transaction and protection of their money. They need reassurance in less familiar environments. There is a growing consideration for use in low value payments (e.g., transit, taxis). There is little international usage of debit. They need reassurance around protection and security of their money and that problems can be resolved. They carry a debit card as an emergency back-up.

It has been found that payment card users in the fifth stage or Stage 5 are using whenever, wherever and are frustrated when they have to use cash.

Payment card user profiles or portraits for the fifth stage or Stage 5 are as follows: debit use—cash is inconvenient; money management—feel very much in control of their finances—debit is the tool that provides this control (except cross-border); openness to change—would use more if they could; cash: POS ratio (% of transactions)—16% cash; 82% POS; 2% cashback; hierarchy of needs—acceptance control (cross-border); and male/female split—41% male/59% female.

For the payment card users in the fifth stage or Stage 5, debit is second nature and cash is a chore. They have a strong debit card habit and want to use the card whenever and wherever they can. It's second nature to use the card for any amount. They carry small amounts of cash (if any) and dislike visits to the ATM. They use cashback to avoid ATM. They get frustrated if merchants don't accept debit cards, and may consider using another merchant for future purchases. They can change their purchase behaviors if surcharging is present to achieve minimum amounts of spend on their debit card.

As indicated herein, the expanded diversity of merchant categories from the lower stages to the higher stages is responsible for accelerating payment card usage behavior change of a payment card user. Merchant categories include those categories associated with each of the plurality of behavior category classifications, and also those categories associated with payment card usage by a payment card user. In accordance with this disclosure, a payment card user is associated with at least one behavior category classification based upon the merchant categories associated with payment card usage by the payment card user that correspond with the merchant categories associated with the behavior category classification.

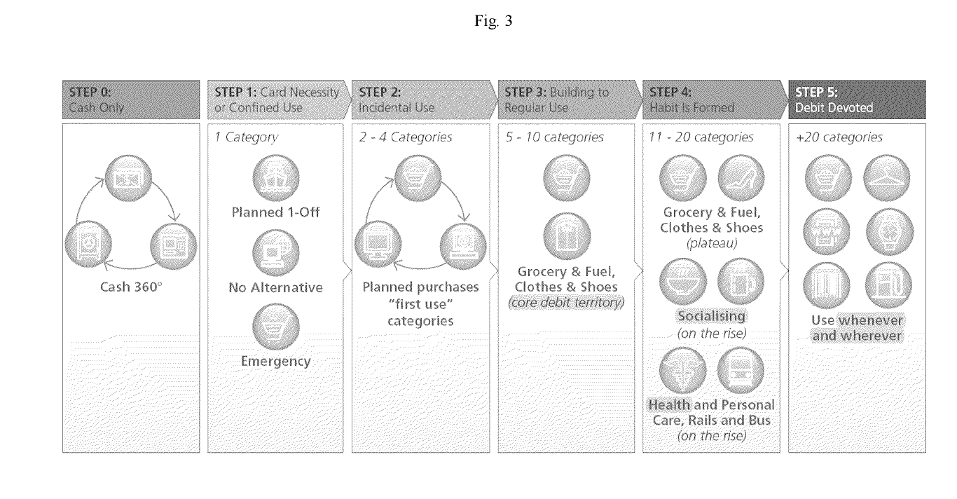

Referring to FIG. 3, illustrative merchant categories for stage 1 include, for example, categories associated with planned 1-off (e.g., motor vehicles, finance, holidays, large ticket item, and the like), no alternative (e.g., iTunes, mail order, and the like), and emergency (e.g., not enough cash at the supermarket). Illustrative merchant categories for stage 2 include, for example, categories associated with planned purchases in multiple “first use” categories (e.g., supermarket, online, large ticket item, and the like). Illustrative merchant categories for stage 3 include, for example, categories associated with grocery, fuel, clothes, shoes, and the like. Illustrative merchant categories for stage 4 include, for example, categories associated with grocery, fuel, socializing, health, personal care, rail, bus, and the like. Illustrative merchant categories for stage 5 include, for example, categories associated with grocery, fuel, socializing, health, personal care, rail, bus, and the like.

In particular, illustrative merchant categories include those categories (with merchant codes) set forth below. Such a variety of merchant categories offers breath and diversity of merchant categories that is required to migration from the lower stages to the higher stages of the accelerate behavior change five stage framework of this disclosure.

| MERCHANT | MERCHANT CATEGORY |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable Services |
| CUE | College, University Education |
| CUF | Clothing, Uniform, Costume Rental |
| DAS | Dating Services |
| DCS | Death Care Services |
| DIS | Discount Department Stores |
| DLS | Dry Cleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal |
| | Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photofinishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data |
| | Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| WHT | Wholesale Trade |

The accelerate behavior change five stage framework of this disclosure has generated important findings with regard to cash, debit, credit, spend categories, payment attitudes, and stage migration.

Debit does not eliminate the need for cash, but it is less prominent in the payments mix as debit adoption grows. Cash continues to play an important role even in higher stages. Customers in lower stages demonstrate greater ATM loyalty. Degrees of ATM loyalty are a likely result of the money management approach of a customer. The lower stages rely heavily on ATMs for mini-statements and balances.

In view of these findings, there is a good opportunity to utilize ATMs for messaging that targets behavioral change, as they are an integral channel for most customers. The impact on ATM transaction volumes should not be overestimated, as investments are made to drive cash to POS substitution.

Significant changes in debit behavior are not always mirrored by attitudes. Acceptance concerns influence debit use at higher stages. Stages 1.1 and 1.2 can demonstrate different levels of POS transaction behavior despite both groups spending in just one merchant category. Stages 1.2 and 2 exhibit very similar debit POS behavior, but distinct attitudinal differences can drive differences in merchant category breadth. Customers in Stage 2 typically feel more in control of their finances providing them with the confidence to use debit more broadly, but at trusted merchants. The proportion of debit use changes significantly between Stages 2 and 3. Debit use is creeping in but this is largely sub-conscious. A conscious increase use of debit (as a preferred payment method) only occurs at Stage 4. There are concerns around acceptance, in smaller or less well known merchants, as a key barrier to using debit in all locations. Consumer willingness to use their debit card overseas is low, even in higher stages. Stages 4 and 5 have a greater proportion of females, indicating that females are more confident using debit.

In view of these findings, separate treatments and message positioning may be needed for customers in Stage 1.1 and 1.2 as their comfort in using debit cards varies so greatly. An understanding of where debit use is being substituted with credit is also needed when developing treatments. Similarly, the attitudinal differences and concerns around control between Stage 1.2 and 2 should be recognized as treatments are developed. Perceptions around acceptance need to be addressed, even at higher stages. Driving international use among higher stages provides a strong incremental revenue opportunity among customers who already exhibit high domestic use.

With regard to findings for credit, customers across the stages are generally credit adverse. The fear of debt is driving their lack of desire to use credit. Those who are using credit view it as an extension of their spending capacity (particularly in the lower stages) or as a debit replacement for certain purchases (particularly large ticket items) where they perceive the security features on credit (e.g., chargebacks) are stronger.

In view of these findings, moving spend from competitor credit cards to debit is a key opportunity area to create a broader payments relationship with the customer. Low credit limits may restrict a customer's ability to spend (e.g., big ticket items). Capturing different types of spend across the two products (debit and credit) can help to optimize overall card payment revenue.

With regard to findings for spend categories, merchant trust and individual approaches to money management are important drivers of consumer confidence to use debit in different categories. The prevalence of different industries in each stage reflects varying definitions of merchant trust and approaches to money management. In lower stages, customers feel comfortable using debit in core debit categories (e.g., groceries and fuel), and those traditionally dominated by larger more established merchants (e.g., big ticket industries). Cash is still perceived to offer more control and security for discretionary spend in smaller merchants. In higher stages, clothing, personal care and socializing over-index as customers look to use debit for discretionary as well as essential spend. As consumers move between stages, transactions plateau in one category and increase in others (e.g., fuel and groceries). Internet use and “not having a choice” in lower stages are important drivers of initial debit use. Over indexing of information, finance and insurance and big ticket items in the lower stages supports this.

In view of these findings, insights on category spend and customer rationale provides a direction for optimizing marketing spend and improving the effectiveness of messaging and incentives for each stage (e.g., customers in Stage 1 are more likely to expand spend to supermarkets before using for socializing). Driving internet spend should form a core part of any debit POS adoption strategy. This channel is an important entry point for debit adoption. One recommendation of the accelerate behavior change five stage framework of this disclosure is to follow the natural flow of spending (e.g., the natural next stages). As indicated herein, another recommendation of the accelerate behavior change five stage framework of this disclosure is the right message (e.g., well targeted) to the right person (e.g., to the relevant stage) at the right time.

With regard to findings for payment attitudes, fear of fraud and need for control are the overarching payment attitudes. The meaning of these and how they are achieved vary across the stages. Control of spend and robust money management is an important need across all stages but with different meanings. In lower stages, cash is the control mechanism and the ATM means of keeping track of finances and spending. In higher stages, debit replaces cash as the means to control and manage spend, with the exception of international use where cash is still used as the control mechanism. A customer's need for control closely evolves around their emotional ties to cash. In lower stages—consumers feel less in control and more wed to cash for its tangibility and immediacy. In higher stages, customers gain more control of their finances and their emotional tie moves from protecting them from themselves to protecting them from loss by external forces. External market factors (e.g. chip and PIN, decline in check acceptance) are important drivers of debit adoption across the stages. Fear of fraud is an overarching influence on card usage (or non-usage). Customers believe that debit exposes their entire account should their card be lost. Customers are largely unaware of card security features and benefits even at higher stages. Speed and access create inertia in the lower stages. Perception that cash is quicker and better addresses need for speed at POS. Cash is thought to provide greater access as accepted everywhere. Experiences of negative merchant attitudes towards debit impact use.

In view of these findings, varying attitudes of a customer towards control and money management should be considered as part of customer treatment design. There is a need for increased focus on effectively communicating the full range of banking solutions (e.g. debit card, ATM, statements, online banking, SMS, and the like) that address the appropriate security or money management concerns of customers depending on the stage that the customer belongs to. A cost/benefit analysis of pro-actively communicating chargeback rights, disputed transaction handling and fraud liability cover should be completed to address the ‘peace of mind’ requirements at each stage. Efforts are needed to address consumer's misconceptions around speed of debit at POS and provide greater confidence around acceptance.

With regard to findings for stage migration, a proportion of customers in all stages show some natural propensity to change behavior. Stages 1.2 and 3 show the highest propensity to naturally move up stages and stay there. Stage 1.2 demonstrates initial comfort with a debit card so category expansion is less of a stage change. Stage 3 demonstrates regular transactional behavior with cash, representing a good opportunity for POS conversion. Stage 1.1 is the most volatile of the groups, particularly over a shorter timeframes. Stages 4 and 1 have the lowest propensity to move up stages. Debit habit is formed at Stage 4 so less scope for natural change.

In view of these findings, a continuous program of activities is needed to migrate customers through the stages and to stem downward migration. Investing in customers who already show a natural propensity for stage change can accelerate the natural behavior change but also achieve a greater breadth of change.

The goal of the accelerate behavior change five stage framework of this disclosure is for optimizing and sustaining behavior change. Stages 1, 3 and 5 have the highest proportion of customers who remain static, when the accelerate behavior change five stage framework is not applied. Customers in Stage 3 have a high level of inertia around payment preferences. Stage 1 has low card engagement so upward behavior change is unlikely. Debit habit is formed at Stages 4 and 5 so less scope for natural change.

In view of these findings, efforts are needed to support sustained migration, particularly of volatile groups that demonstrate a high propensity to move down stages. Even after habit is formed (i.e., Stages 4 and 5) there is still a risk of customers moving backwards so ongoing efforts are needed to ensure profitable behavior is sustained. Achieving stage migration among Stage 3 customers who demonstrate high levels of inertia and no natural behavior change over time will require a focused effort. Once achieved, opportunity for return and impact is high owing to the size of this segment and scope for upward behavior change.

Algorithms can be employed to determine formulaic descriptions of the integration of the data source information to formulate the accelerate behavior change five stage framework of this disclosure using any of a variety of known mathematical techniques. These formulas, in turn, can be used to derive or generate one or more analyses and updates for the accelerate behavior change five stage framework of this disclosure using any of a variety of available trend analysis algorithms. For example, these formulas can be used to determine a plurality of behavior category classifications based upon payment card usage in which the behavior category classifications range from cash use preference behavior to payment card use preference behavior; identify a number of merchant categories associated with each of the plurality of behavior category classifications; identify a number of merchant categories associated with payment card usage by a payment card user; and associate the payment card user with at least one behavior category classification based upon the number of merchant categories associated with payment card usage by the payment card user that correspond with the number of merchant categories associated with the behavior category classification.

In the development of the accelerate behavior change five stage framework of this disclosure, the methodology involved in analyzing, determining, identifying and associating the information and data involved over 5 million consumers, 4 different markets, 24 months of transaction data, and over 60 different data points. This data and information was incorporated into algorithms to facilitate development of the accelerate behavior change five stage framework of this disclosure.

It will be understood that the present disclosure can be embodied in a computer readable non-transitory storage medium storing instructions of a computer program which when executed by a computer system results in performance of stages of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, stages or components, but not precluding the presence of one or more other features, integers, stages or components or groups thereof

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, stages associated with the processes described herein can be performed in any order, unless otherwise specified or dictated by the stages themselves. The present disclosure is intended to embrace all such alternatives, modifications and variances that fall within the scope of the appended claims.

What is claimed is:

1. A method for accelerating payment card usage behavior change of a payment card user, said method comprising:
identifying a number of merchant categories associated with payment card usage by a payment card user; and
associating payment card usage by the payment card user with an increasing number of merchant categories.

2. A method comprising:
determining a plurality of behavior category classifications based upon payment card usage, wherein the plurality of behavior category classifications range from cash use preference behavior to payment card use preference behavior;
identifying a number of merchant categories associated with each of the plurality of behavior category classifications;
identifying a number of merchant categories associated with payment card usage by a payment card user; and
associating the payment card user with at least one of the plurality of behavior category classifications based upon the number of merchant categories associated with payment card usage by the payment card user that correspond with the number of merchant categories associated with the at least one behavior category classification.

3. The method of claim 2, further comprising:
migrating the payment card user from the at least one behavior category classification to another of the plurality of behavior category classifications based on payment card usage by the payment card user that includes an increasing or decreasing number of merchant categories.

4. The method of claim 2, wherein the payment card is a debit card.

5. The method of claim 2, wherein each of the plurality of behavior category classifications comprise:
optionally a control stage that comprises cash use preference behavior;
a first stage that comprises payment card necessity or confined payment card use behavior;
a second stage that comprises incidental payment card use behavior;
a third stage that comprises regular payment card use building behavior;
a fourth stage that comprises payment card use habit forming behavior; and
a fifth stage that comprises payment card use preference behavior.

6. The method of claim 5, wherein, for an emerging market, the first stage comprises at least 1 merchant category, the second stage comprises from about 2 to about 3 different merchant categories, the third stage comprises from about 4 to about 6 different merchant categories, the fourth stage comprises from about 7 to about 14 different merchant categories, and the fifth stage comprises from about 15 to about 35 different merchant categories; for an advanced market, the first stage comprises at least 1 merchant category, the second stage comprises from about 2 to about 4 different merchant categories, the third stage comprises from about 5 to about 10 different merchant categories, the fourth stage comprises from about 11 to about 20 different merchant categories, and the fifth stage comprises from about 21 to about 41 different merchant categories; and for a mature market, the first stage comprises at least 1 merchant category, the second stage comprises from about 2 to about 4 different merchant categories, the third stage comprises from about 5 to about 9 different merchant categories, the fourth stage comprises from about 10 to about 22 different merchant categories, and the fifth stage comprises from about 23 to about 52 different merchant categories.

7. The method of claim 6, wherein the merchant categories for the first stage, the second stage, the third stage, the fourth stage and the fifth stage are independently selected from the group consisting of:

| MERCHANT | MERCHANT CATEGORY |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable Services |
| CUE | College, University Education |
| CUF | Clothing, Uniform, Costume Rental |
| DAS | Dating Services |
| DCS | Death Care Services |
| DIS | Discount Department Stores |
| DLS | Dry Cleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal |
| | Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photofinishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data |
| | Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| WHT | Wholesale Trade |

8. The method of claim 2, further comprising:
one or more computers having computer readable mediums having stored thereon instructions which, when executed by one or more processors of the one or more computers, performs the stages of:
determining the plurality of behavior category classifications based upon payment card usage, wherein the plurality of behavior category classifications range from cash use preference behavior to payment card use preference behavior;
identifying a number of merchant categories associated with each of the plurality of behavior category classifications;
identifying a number of merchant categories associated with payment card usage by a payment card user; and
associating the payment card user with at least one of the plurality of behavior category classifications based upon the number of merchant categories associated with payment card usage by the payment card user that correspond with the number of merchant categories associated with the at least one behavior category classification.

9. A payment card usage behavior category classification system which comprises the following stages:
optionally a control stage that comprises cash use preference behavior;
a first stage that comprises payment card necessity or confined payment card use behavior;
a second stage that comprises incidental payment card use behavior;
a third stage that comprises regular payment card use building behavior;
a fourth stage that comprises payment card use habit forming behavior; and
a fifth stage that comprises payment card use preference behavior.

10. The payment card usage behavior category classification system of claim 9, wherein the payment card is a debit card.

11. The payment card usage behavior category classification system of claim 9, wherein, for an emerging market, the first stage comprises at least 1 merchant category, the second stage comprises from about 2 to about 3 different merchant categories, the third stage comprises from about 4 to about 6 different merchant categories, the fourth stage comprises from about 7 to about 14 different merchant categories, and the fifth stage comprises from about 15 to about 35 different merchant categories; for an advanced market, the first stage comprises at least 1 merchant category, the second stage comprises from about 2 to about 4 different merchant categories, the third stage comprises from about 5 to about 10 different merchant categories, the fourth stage comprises from about 11 to about 20 different merchant categories, and the fifth stage comprises from about 21 to about 41 different merchant categories; and for a mature market, the first stage comprises at least 1 merchant category, the second stage comprises from about 2 to about 4 different merchant categories, the third stage comprises from about 5 to about 9 different merchant categories, the fourth stage comprises from about 10 to about 22 different merchant categories, and the fifth stage comprises from about 23 to about 52 different merchant categories.

12. The payment card usage behavior category classification system of claim 11, wherein the merchant categories for the first stage, the second stage, the third stage, the fourth stage and the fifth stage are independently selected from the group consisting of:

| MERCHANT | MERCHANT CATEGORY |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable Services |
| CUE | College, University Education |
| CUF | Clothing, Uniform, Costume Rental |
| DAS | Dating Services |
| DCS | Death Care Services |
| DIS | Discount Department Stores |
| DLS | Dry Cleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal |
| | Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photofinishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data |
| | Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| WHT | Wholesale Trade |

13. The payment card usage behavior category classification system of claim 9, further comprising:
one or more computers having computer readable mediums having stored thereon instructions which, when executed by one or more processors of the one or more computers, performs the stages of:
identifying a number of merchant categories associated with the first stage, the second stage, the third stage, the fourth stage and the fifth stage;
identifying a number of merchant categories associated with payment card usage by a payment card user; and
associating the payment card user with at least one of the first stage, the second stage, the third stage, the fourth stage and the fifth stage based upon the number of merchant categories associated with payment card usage by the payment card user that correspond with the number of merchant categories associated with the first stage, the second stage, the third stage, the fourth stage and the fifth stage.

14. A system comprising:
one or more computers having computer readable mediums having stored thereon instructions which, when executed by one or more processors of the one or more computers, causes the system to perform the stages of:
determining a plurality of behavior category classifications based upon payment card usage, wherein the behavior category classifications range from cash preference behavior to payment card preference behavior;
identifying a number of merchant categories associated with each of the plurality of behavior category classifications;
identifying a number of merchant categories associated with payment card usage by a payment card user; and
associating the payment card user with at least one of the plurality of behavior category classifications based upon the number of merchant categories associated with payment card usage by the payment card user that correspond with the number of merchant categories associated with the at least one behavior category classification.

15. The system of claim 14, wherein the payment card is a debit card.

16. The system of claim 14, wherein each of the plurality of behavior category classifications comprise:
optionally a control stage that comprises cash use preference behavior;
a first stage that comprises payment card necessity or confined payment card use behavior;
a second stage that comprises incidental payment card use behavior;
a third stage that comprises regular payment card use building behavior;
a fourth stage that comprises payment card use habit forming behavior; and
a fifth stage that comprises payment card use preference behavior.

17. The system of claim 16, wherein for an emerging market, the first stage comprises at least 1 merchant category, the second stage comprises from about 2 to about 3 different merchant categories, the third stage comprises from about 4 to about 6 different merchant categories, the fourth stage comprises from about 7 to about 14 different merchant categories, and the fifth stage comprises from about 15 to about 35 different merchant categories; for an advanced market, the first stage comprises at least 1 merchant category, the second stage comprises from about 2 to about 4 different merchant categories, the third stage comprises from about 5 to about 10 different merchant categories, the fourth stage comprises from about 11 to about 20 different merchant categories, and the fifth stage comprises from about 21 to about 41 different merchant categories; and for a mature market, the first stage comprises at least 1 merchant category, the second stage comprises from about 2 to about 4 different merchant categories, the third stage comprises from about 5 to about 9 different merchant categories, the fourth stage comprises from about 10 to about 22 different merchant categories, and the fifth stage comprises from about 23 to about 52 different merchant categories.

18. The system of claim 17, wherein the merchant categories for the first stage, the second stage, the third stage, the fourth stage and the fifth stage are independently selected from the group consisting of:

| MERCHANT | MERCHANT CATEGORY |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable Services |
| CUE | College, University Education |
| CUF | Clothing, Uniform, Costume Rental |
| DAS | Dating Services |
| DCS | Death Care Services |
| DIS | Discount Department Stores |
| DLS | Dry Cleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal |
| | Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photofinishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data |
| | Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| WHT | Wholesale Trade |
